(19) United States
(12) Patent Application Publication
(10) Pub. No.: US 2019/0327457 A1
(43) Pub. Date: Oct. 24, 2019

(54) PROJECTION CONTROL APPARATUS AND PROJECTION CONTROL METHOD

(71) Applicant: CANON KABUSHIKI KAISHA, Tokyo (JP)

(72) Inventors: Yuta Urano, Kawasaki-shi (JP); Kazuhiro Monden, Inagi-shi (JP)

(21) Appl. No.: 16/380,902

(22) Filed: Apr. 10, 2019

(30) Foreign Application Priority Data
Apr. 20, 2018 (JP) 2018-081157
Apr. 20, 2018 (JP) 2018-081158

(51) Int. Cl. H04N 9/31; G06T 5/00; G06T 5/50

(52) U.S. Cl. CPC H04N 9/3185; G06T 5/50; H04N 9/3194; G06T 5/006

(57) ABSTRACT

A projection control apparatus that controls a plurality of projection apparatuses including a first projection apparatus configured to project a first projected image and a second projection apparatus configured to project a second projected image, includes an acquisition unit configured to acquire a common area in which the first projected image and the second projected image are deformable, and a control unit configured to cause at least one of the plurality of projection apparatuses to project an image representing the common area.

### BACKGROUND

### Field of the Disclosure

The present disclosure relates to a projection control apparatus and a projection control method for controlling a plurality of projection apparatuses.

### Description of the Related Art

A projection method (stack projection) in which projection positions of a plurality of projectors (projection apparatuses) are overlapped (stacked) is known. In the stack projection in which projection alignment between projectors is required, projectors having a function that facilitates the alignment are also known.

A distortion (trapezoidal distortion) occurs in the shape of a projected image, except in a case of performing projection from a directly-facing position where an optical axis of a projector and a projection surface for the projector are orthogonal to each other. As a function for correcting the trapezoidal distortion without changing the position of the projector, a keystone correction function is known. The keystone correction function can be implemented by deforming an image on a liquid crystal panel so as to compensate for the trapezoidal distortion.

A technique for overlapping projection positions of a plurality of projectors by applying the keystone correction function is known.

In the keystone correction, a deformable range of a projected image is limited in some cases due to constraints of a hardware or software configuration. In a technique discussed in Japanese Patent Application Laid-Open No. 2009-200557, an image indicating a deformable range for keystone correction is superimposed on a projected image, to thereby provide a user with information indicating how to correct a trapezoidal distortion.

To implement the stack projection, the keystone correction function is often used for each of a plurality of projectors. The optical axes of the plurality of projectors are not parallel to each other in many cases. Accordingly, different amounts of deformation for keystone correction are set to the plurality of projectors. In addition, it is necessary to set target projection positions (e.g., screen corners) so as to fall within respective deformable ranges of all projectors used for stack projection.

Thus, if a deformable range common to the plurality of projectors is unknown, it is extremely troublesome for a user to perform the alignment.

However, in the technique discussed in Japanese Patent Application Laid-Open No. 2009-200557, the case of using a plurality of projectors is not taken into consideration.

### SUMMARY

The present disclosure is directed to a projection control apparatus capable of facilitating alignment of images projected by a plurality of projection apparatuses.

According to an aspect of the present disclosure, a projection control apparatus that controls a plurality of projection apparatuses including a first projection apparatus configured to project a first projected image and a second projection apparatus configured to project a second projected image includes an acquisition unit configured to acquire a common area in which the first projected image and the second projected image are deformable, and a control unit configured to cause at least one of the plurality of projection apparatuses to project an image representing the common area.

Further features of the present disclosure will become apparent from the following description of exemplary embodiments with reference to the attached drawings.

### BRIEF DESCRIPTION OF THE DRAWINGS

FIG. 1 is a schematic diagram illustrating a configuration example of a projection system that performs stack projection according to a first exemplary embodiment.

FIG. 2 is a block diagram illustrating a functional configuration example of the projection system according to the first exemplary embodiment.

FIG. 3 is a graph related to keystone correction.

FIG. 4 is a schematic diagram relating to a deformable amount of keystone correction.

FIG. 5 is a flowchart illustrating an outline of automatic alignment processing according to the first exemplary embodiment.

FIG. 6 illustrates an example of a graphical user interface (GUI) for selecting a projector according to the first exemplary embodiment.

FIG. 7 illustrates an example of a GUI for selecting a camera according to the first exemplary embodiment.

FIG. 8 illustrates an example of a GUI for setting camera parameters according to the first exemplary embodiment.

FIG. 9 illustrates an example of a GUI for selecting an alignment mode according to the first exemplary embodiment.

FIG. 10 is a flowchart illustrating automatic alignment processing according to the first exemplary embodiment.

FIG. 11A illustrates an example of a camera coordinate plane, and FIG. 11B illustrates an example of a projector coordinate plane.

FIG. 12 is a flowchart illustrating projection geometry designation processing according to the first exemplary embodiment.

FIGS. 13A and 13B are diagrams each relating to a deformable area on a projector coordinate plane, and FIGS. 13C and 13D are diagrams each relating to a deformable area on a camera coordinate plane.

FIGS. 14A and 14B each illustrate an example of deformed shape designation markers and deformable area markers according to the first exemplary embodiment.

FIG. 15 illustrates an example of a GUI for designating a projection geometry according to the first exemplary embodiment.

FIG. 16 is a flowchart illustrating projection geometry designation processing according to a second exemplary embodiment.

FIG. 17A illustrates a deformable area by a projector 100a, FIG. 17B illustrates a deformable area by a projector 100b, and FIG. 17C illustrates a captured image of a marker image, according to the second exemplary embodiment.

FIG. 18 is a flowchart illustrating projection geometry designation processing according to a third exemplary embodiment.

### DESCRIPTION OF THE EMBODIMENTS

Exemplary embodiments of the present disclosure will be described in detail below with reference to the accompanying drawings. The present disclosure is not limited to the following exemplary embodiments. Not all components described in the exemplary embodiments are essential for the present disclosure. Functional blocks described in the exemplary embodiments can be implemented by hardware components, software components, or a combination thereof. One functional block may be implemented by a plurality of hardware components. A plurality of functional blocks may be implemented by one hardware component. One or more functional blocks may be implemented in such a manner that at least one programmable processor such as a central processing unit (CPU) or a micro processing unit (MPU) executes a computer program loaded into at least one memory. If one or more functional blocks are implemented by hardware, the functional blocks can be implemented by a discrete circuit or an integrated circuit such as a field-programmable gate array (FPGA) or an application specific integrated circuit (ASIC).

The following exemplary embodiments illustrate a configuration in which the present disclosure is applied to a stand-alone projection apparatus (projector). However, for example, the present disclosure can also be applied to a projector incorporated in a general electronic apparatus, such as a personal computer (PC), a smartphone, a tablet terminal, a game console, or a digital (video) camera.

The following exemplary embodiments may be described with reference to figures illustrating a graphical user interface (GUI), but the GUIs are illustrated by way of example only. Omissions, replacements, or modifications can be made on the layout of each GUI, the type of each component, screen transition, and the like without departing from the gist of the present disclosure.

### [System Configuration]

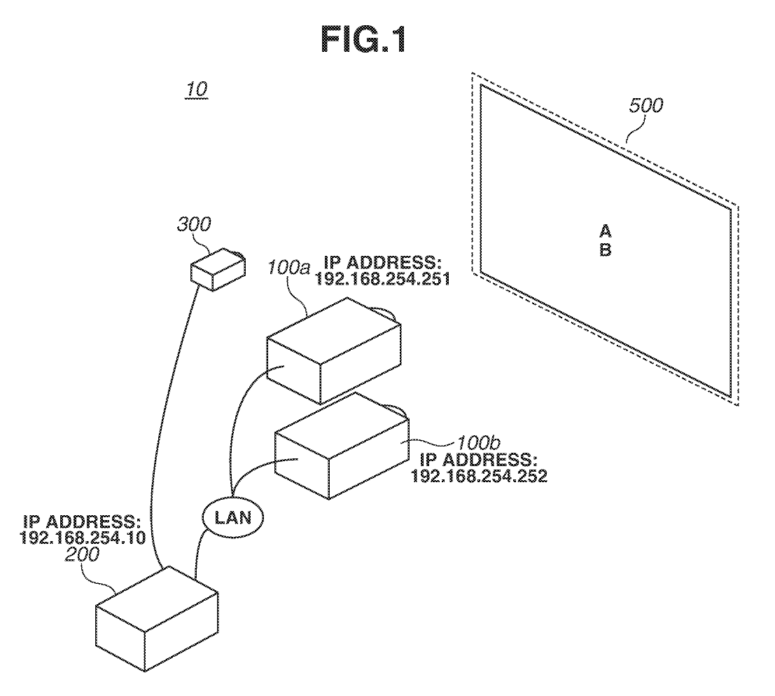

FIG. 1 is a schematic diagram illustrating an example of a projection system according to a first exemplary embodiment of the present disclosure. A projection system 10 performs stack projection in which projection areas of a plurality of projectors are overlapped and aligned on a projection surface 500 so as to enlarge a dynamic range of a projected image, improve luminance, or achieve a three-dimensional (3D) display. FIG. 1 illustrates the projection system 10 in which projection areas A and B of two projectors 100a and 100b are aligned. The present disclosure can also be applied to a projection system in which projection areas of three or more projectors are aligned.

All projectors included in the projection system 10 are communicably connected to a PC 200 that functions as a projection control apparatus. The present exemplary embodiment illustrates an example in which a PC is used as the projection control apparatus, but instead other information processing apparatuses, such as a smartphone and a tablet, may be used. Communications between the projection control apparatus and a plurality of projectors may be established by a wired communication or a wireless communication, and a communication protocol is not particularly limited. The present exemplary embodiment illustrates an example in which communication is established between apparatuses via a local area network (LAN) using Transmission Control Protocol/Internet Protocol (TCP/IP) as a communication protocol.

The PC 200 transmits a predetermined command to each of the projectors 100a and 100b, thereby making it possible to control operations of the projectors 100a and 100b. Each of the projectors 100a and 10013 performs an operation based on the command received from the PC 200, and transmits the operation result to the PC 200.

The projection system 10 further includes an image capturing apparatus camera. 300 as an image capturing unit. The image capturing apparatus 300 is, for example, a digital camera, a web camera, or a network camera. Alternatively, an image capturing apparatus incorporated in the projector 100 or the PC 200 may be used. Assume that the image capturing apparatus is installed so as to include the entire projection surface as an image capturing range. When an image capturing apparatus located outside of the PC 200 is used, the image capturing apparatus is communicably connected to the PC 200 directly or via a LAN. The PC 200 transmits a predetermined command to the image capturing apparatus 300, thereby making it possible to control the operation of the image capturing apparatus 300. For example, the image capturing apparatus 300 can capture an image in response to a request from the PC 200, and can transmit data on the captured image to the PC 200.

### [Configuration of Projector 100]

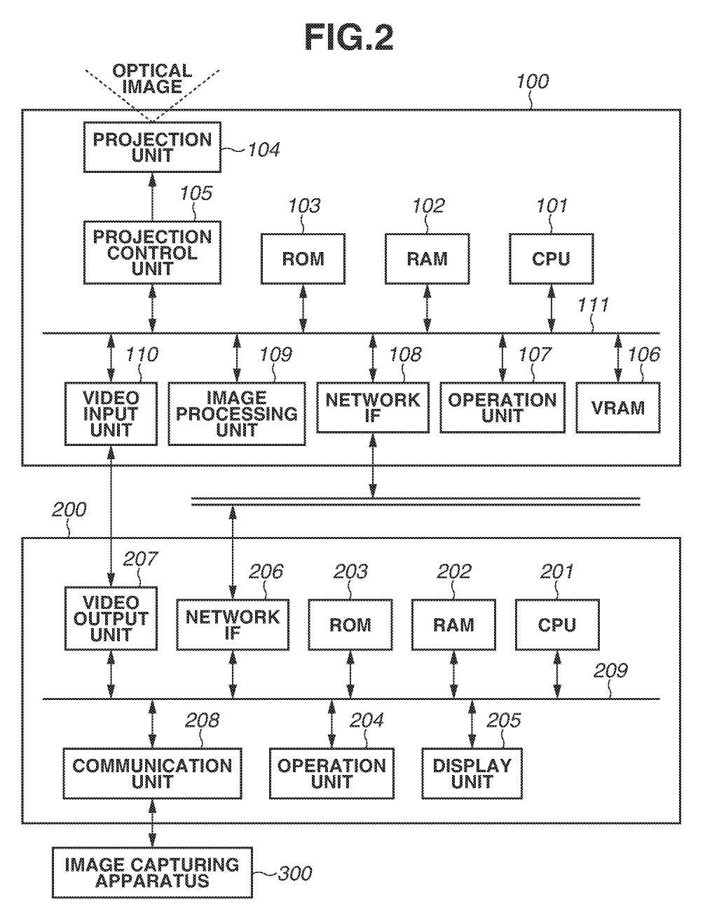

FIG. 2 is a block diagram illustrating a functional configuration example of the projector 100 and the PC 200 included in the projection system 10. The projector 100 includes a central processing unit (CPU) 101, a random access memory (RAM) 102, a read-only memory (ROM) 103, a projection unit 104, a projection control unit 105, a video RAM (VRAM) 106, an operation unit 107, a network interface (IF) 108, an image processing unit 109, and a video input unit 110. These functional blocks are communicably connected to each other via an internal bus 111.

The CPU 101 is an example of a programmable processor, and implements the operation of the projector 100 by, for example, loading a program stored in the ROM 103 into the RAM 102 and executing the program.

The RAM 102 is used as a work memory for the CPU 101 to execute programs. The RAM 102 stores programs and variables and the like to be used for executing the programs. The RAM 102 may also be used for other applications such as a data buffer.

The ROM 103 may be rewritable. The ROM 103 stores programs to be executed by the CPU 101, GUI data used for displaying a menu screen, various setting values, and the like.

The projection unit 104 includes a light source and a projection optical system including a lens, and projects an optical image based on an image for projection supplied from the projection control unit 105. In the present exemplary embodiment, a liquid crystal panel is used as an optical modulation element, and by controlling the reflectance or transmittance of light from the light source based on the image for projection, an optical image is generated based on the image for projection and the generated optical image is projected onto the projection surface by the projection optical system.

The projection control unit 105 supplies the projection unit 104 with the projection image data supplied from the image processing unit 109.

The VRAM 106 is a video memory that stores the projection image data received from an external apparatus such as a PC or a media player.

The operation unit 107 is an acceptance unit that includes input devices such as a key button, a switch, and a touch panel, and accepts an instruction from a user to the projector 100. The CPU 101 monitors the operation of the operation unit 107. Upon detecting the operation of the operation unit 107, the CPU 101 executes processing based on the detected operation. When the projector 100 includes a remote controller, the operation unit 107 notifies the CPU 1111 of an operation signal received from the remote controller.

The network IF 108 is an interface for connecting the projector 100 to a communication network, and has a configuration that is compliant with the standards of supported communication networks. In the present exemplary embodiment, the projector 100 is connected to a local network common to the PC 200 via the network IF 108. Accordingly, communications between the projector 100 and the PC 200 are executed via the network IF 108.

The image processing unit 109 applies, as needed, various image processing on video signals, which are supplied to the video input unit 110 and stored in the VRAM 106, and supplies the video signals to the projection control unit 105. The image processing unit 109 may be, for example, a microprocessor for image processing. Alternatively, the function corresponding to the image processing unit 109 may be implemented by the CPU 101 executing a program stored in the ROM 103.

Examples of the image processing that can be applied by the image processing unit 109 include frame thinning processing, frame interpolation processing, resolution conversion processing, processing of superimposing an on-screen display (OSD) such as a menu screen, keystone correction processing, and edge blending processing. However, the image processing is not limited to these examples.

The video input unit 110 is an interface for directly or indirectly receiving video signals output from an external apparatus, which is the PC 200 in the present exemplary embodiment, and has a configuration that corresponds to the supported video signals. The video input unit 110 includes, for example, at least one of a composite terminal, an S-video terminal, a D-terminal, a component terminal, an analog red, green, and blue (RGB) terminal, a Digital Visual Interface-Integrated (DVI-I) terminal, a Digital Visual Interface Digital (DVI-D) terminal, and a High-Definition Multimedia Interface (HDMI®) terminal. Upon receiving an analog video signal, the video input unit 110 converts the analog video signal into a digital video signal, and stores the digital video signal in the VRAM 106.

### [Configuration of PC 200]

Next, the functional configuration of the PC 200 will be described. The PC 200 may be a general-purpose computer to which an external display can be connected, and thus has a functional configuration of the general-purpose computer. The PC 200 includes a CPU 201, a RAM 202, a ROM 203, an operation unit 204, a display unit 205, a network IF 206, a video output unit 207, and a communication unit 208. These functional blocks are communicably connected to each other via an internal bus 209.

The CPU 201 is an example of a programmable processor, and implements the operation of the PC 200 by, for example, loading programs such as an operating system (OS) and an application program into the ROM 203, and executing the loaded programs.

The RAM 202 is used as a work memory for the CPU 201 to execute programs. The RAM 202 stores programs and variables and the like used for executing the programs. The RAM 202 may be used for other applications such as a data buffer.

The ROM 203 may be rewritable. The ROM 203 stores programs to be executed by the CPU 201, GUI data used for displaying a menu screen, various setting values, and the like. The PC 200 may include a storage device (hard disk drive (HDD) or a solid state drive (SSD)) having a capacity larger than that of the RAM 203. In this case, programs such as an OS and an application program may be stored in such a storage device.

The operation unit 204 includes input devices such as a keyboard, a pointing device (e.g., a mouse), a touch panel, and a switch, and accepts an instruction from the user to the PC 200. The keyboard may be a software keyboard. The CPU 201 monitors the operation of the operation unit 204. Upon detecting the operation of the operation unit 204, the CPU 201 executes processing based on the detected operation.

The display unit 205 is, for example, a liquid crystal panel or an organic electroluminescent (EL) panel. The display unit 205 displays a screen provided by an OS or an application program. The display unit 205 may be an external apparatus, or may be a touch display.

The network IF 206 is an interface for connecting the PC 200 to a communication network, and has a configuration that is compliant with the standards of communication networks. In the present exemplary embodiment, the PC 200 is connected to a local network common to the projector 100 through the network IF 206. Accordingly, communications between the PC 200 and the projector 100 are executed through the network IF 206.

The video output unit 207 is an interface for transmitting a video signal to an external apparatus, which is the projector 100 or the image capturing apparatus 300 in the present exemplary embodiment, and has a configuration that corresponds to the supported video signals. The video output unit 207 includes, for example, at least one of a composite terminal, an S-video terminal, a D-terminal, a component terminal, an analog RGB terminal, a DVI-I terminal, a DVI-D terminal, and an HDMI® terminal.

In the present exemplary embodiment, assume that a UI screen for a projection control application program including a function for adjusting the projection area of the projector 100 is displayed on the display unit 205, but instead the UI screen may be displayed on an external apparatus connected to the video output unit 207.

The communication unit 208 is a communication interface for performing, for example, serial communications with an external apparatus. A typical example of the communication unit 208 is a universal serial bus (USB) interface. The communication unit 208 may have a configuration that is compliant with other standards such as Recommended Standard (RS)-232C. In the present exemplary embodiment, assume that the image capturing apparatus 300 is connected to the communication unit 208. However, the method for establishing communication between the image capturing apparatus 300 and the PC 200 is not particularly limited and the communication can be established based on any standards supported by both the image capturing apparatus 300 and the PC 200.

### [Regarding Keystone Correction]

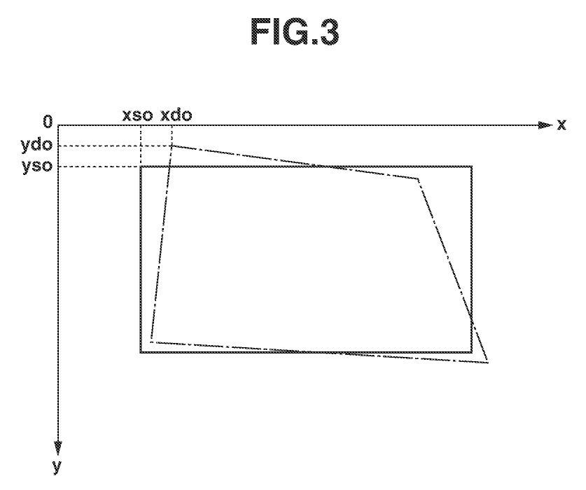

Next, the keystone correction will be described with reference to FIG. 3. The keystone correction is a correction (geometric correction) for geometrically converting (deforming) an original image so as to compensate for a trapezoidal distortion caused in a projected image due to a misalignment between a normal direction to the projection surface and a projection direction (generally, an optical axis of the projection optical system). Since the image geometric conversion can be implemented by projective transformation, the keystone correction is equivalent to determination of parameters for projective transformation as a correction amount for geometric correction. For example, the CPU 101 can determine parameters for projective transformation based on a movement amount and a movement direction of each vertex of the original image on a rectangle, and can provide the determined parameters to the image processing unit 109.

For example, assuming that the original image is represented by coordinate (xs, ys), coordinate (xd, yd) of a deformed image obtained after projective transformation are represented by the following Expression (1).

$$( \begin{matrix}xd \\ y d \\ 1\end{matrix} ) = M ( \begin{matrix}xs - xso \\ ys - yso \\ 1\end{matrix} ) + ( \begin{matrix}xdo \\ ydo \\ 0\end{matrix} ) \qquad ( 1 )$$

In Expression (1), M represents a 3×3 matrix, which is a projective transformation matrix from the original image to the deformed image. In Expression (1), xso and yso represent coordinates of the upper left vertex of the original image indicated by a solid line in FIG. 3, and xdo and ydo represent vertex coordinate values corresponding to the vertices (xso, yso) of the original image in the deformed image indicated by a dashed-dotted line in FIG. 3.

The CPU 101 provides the image processing unit 109 with the matrix M in Expression 1 and an inverse matrix M⁻¹ of the matrix M, together with offset values (xso, yso) and (xdo, ydo), as parameters for keystone correction. The image processing unit 109 can obtain the coordinate (xs, ys) of the original image corresponding to the coordinate value (xd, yd) obtained after the keystone correction based on the following Expression 2.

$$( \begin{matrix}xs \\ ys \\ 1\end{matrix} ) = {M}^{- 1} ( \begin{matrix}xd - xdo \\ y d - ydo \\ 1\end{matrix} ) + ( \begin{matrix}xso \\ yso \\ 0\end{matrix} ) \qquad ( 2 )$$

If both of the coordinates xs and ys) of the original image obtained by Expression 2 are integers, the image processing unit 109 can use the pixel value corresponding to the coordinate (xs, ys) of the original image as the pixel value corresponding to the coordinate (xd, yd) of the image obtained after keystone correction. On the other hand, if the coordinates of the original image obtained by Expression 2 are not integers, the image processing unit 109 can obtain the pixel value corresponding to the coordinate (xs, ys) of the original image by interpolation calculation using values of a plurality of peripheral pixels. The interpolation calculation can be performed using, for example, any one of known interpolation calculations such as bilinear interpolation and bicubic interpolation. If the coordinates of the original image obtained by Expression 2 are coordinates of an external area of the original image, the image processing unit 109 sets the pixel value corresponding to the coordinate (xd, yd) of the image obtained after the keystone correction as black (0) or a background color set by the user. In this manner, the image processing unit 109 can obtain pixel values for all coordinates of the image obtained after the keystone correction, and can create a converted image.

In this case, both the matrix M and the inverse matrix M⁻¹ of the matrix M are supplied to the image processing unit 109 from the CPU 101 of each projector 100, but only one of the matrix M and the inverse matrix M⁻¹ may be supplied thereto and the other one of the matrix M and the inverse matrix M⁻¹ may be obtained by the image processing unit 109.

The coordinates of each vertex of the image obtained after the keystone correction can be acquired by making the user input the movement amount through the operation unit 107 so as to project, for example, each vertex of a projected image at a desired position. In this case, to support the input of the movement amount, the CPU 201 may cause the projector 100 to project a test pattern by using functions of the projection control application program.

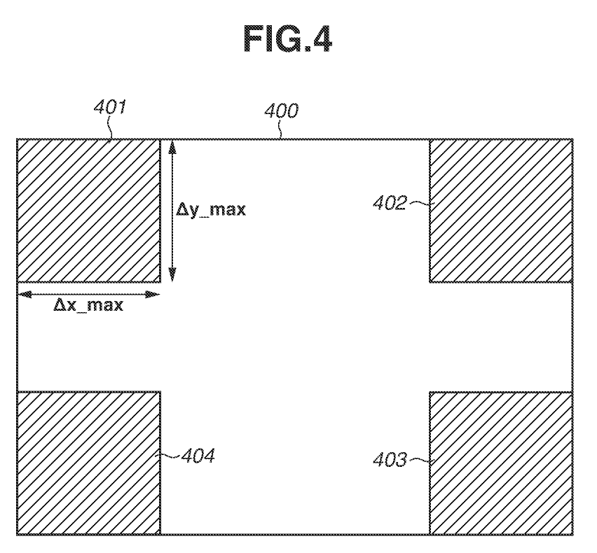

In the keystone correction, a deformable range of a projected image is limited in some cases due to constraints of hardware or software configuration. FIG. 4 is a schematic diagram illustrating a deformable amount of the keystone correction. FIG. 4 illustrates a projector panel plane 400. A shaded area 401 illustrated in FIG. 4 represents a deformable area in which the upper left vertex is movable during keystone correction. Shaded areas 401 to 404 represent deformable areas respectively corresponding to four vertices of a rectangular panel. In FIG. 4, Δx_max represents a maximum deformable amount in an x-axis direction, and Δy_max represents a maximum deformable amount in a y-axis direction.

The maximum deformable amounts Δx_max and Δy_max may vary depending on the hardware or software configuration of each projector. Like in Japanese Patent Application Laid-Open No. 2009-200557, Δx_max and Δy_max may be set so as to make each deformable area similar to a maximum pixel area of the panel. For example, Δx_max and Δy_max may be set to 500 pixels so that each deformable area has a square shape.

### [Automatic Alignment Processing]

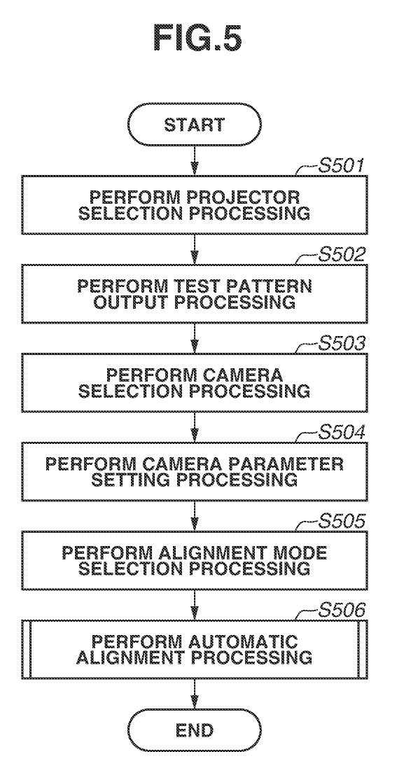

FIG. 5A is a flowchart of illustrating an outline of automatic alignment processing implemented by the PC 200 according to the present exemplary embodiment executing the projection control application program.

In step S501, the CPU 201 of the PC 200 selects a plurality of projectors to be subjected to automatic alignment processing from among the projectors 100 with which the PC 200 can communicate.

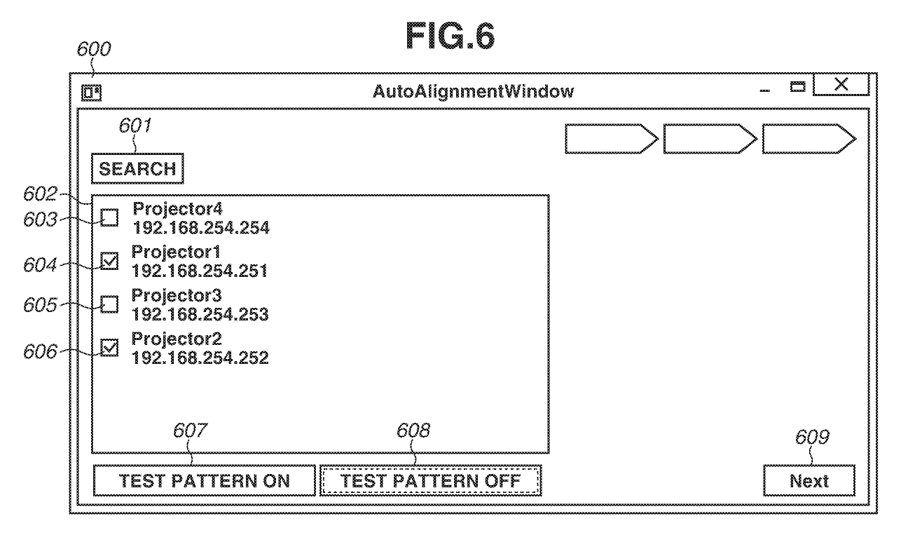

FIG. 6 illustrates an example of a GUI screen 600 to be displayed on the display unit 205 when the CPU 201 executes the projection control application program. The user operates the screen 600 through the operation unit 204 of the PC 200.

If the CPU 201 detects that a “search” button 601 is pressed by the user, the CPU 201 broadcasts a predetermined command for requesting information about a projector name and an IP address on a network through the network IF 206. The information requested in this case is not limited to the projector name and the IP address. For example, a keystone deformable amount or the like may also be requested in advance.

Upon receiving a command through the network IF 108, the CPU 101 of each projector 100 connected to the network transmits, to the PC 200, data including information indicating the projector name and the IP address of the projector 100. The CPU 201 of the PC 200 receives data transmitted in response to the command, extracts information included in the data, and displays the information on a list view 602. The order of projectors to be displayed on the list view 602 may be the detected order of projectors. Alternatively, the projectors may be sorted based on a specific rule.

The user selects projectors to be subjected to alignment processing by, for example, checking checkboxes 603 to 606. The screen 600 illustrates an example of a case where four projectors 100 are connected to the PC 200.

When the projector 100a (Projector1) and the projector 100b (Projector2) are used as projectors to be subjected to alignment processing, the checkboxes 604 and 606 may be checked.

Information such as a projector name and an IP address about the projectors for which the checkbox is checked is stored in the RAM 202 of the PC 200.

If an operation on a “test pattern ON” button 607 illustrated in FIG. 6 is detected, the CPU 201 transmits a command for instructing display of a test pattern through the network IF 206 to each of the plurality of projectors for which the checkbox is checked. This operation corresponds to step S502 in the processing flow illustrated in FIG. 5. The test pattern to be displayed based on the operation on the button 606 is a test pattern for facilitating checking of the size and position of a display area of each projector 100. For example, a lattice-like image is displayed as the test pattern. The test pattern may be transmitted to each projector 100 from the PC 200 in association with the command for instructing display of the test pattern, or may be transmitted in combination with a plurality of commands for causing each projector to render any straight line, figure, or character string, or the like.

If an operation on a “test pattern OFF” button 608 illustrated in FIG. 6 is detected, the CPU 201 transmits, to each projector for which the checkbox is checked, a command for instructing non-display of the test pattern through the network IF 206.

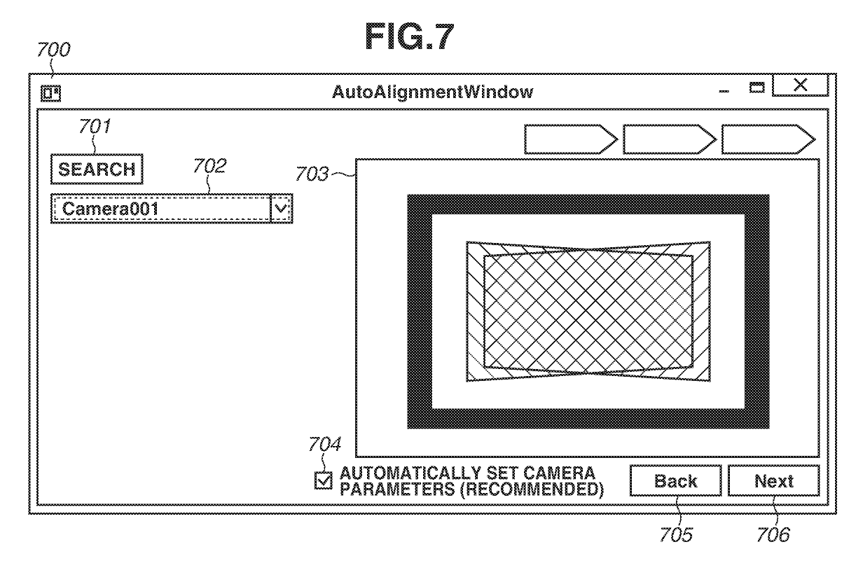

If an operation on a “next” button 609 illustrated in FIG. 6 is detected, the screen transitions to a camera selection screen 700 illustrated in FIG. 7. This operation corresponds to a shift from step S502 to step S503 in FIG. 5.

In step S503 illustrated in FIG. 5, a camera to be used for automatic alignment processing is selected. FIG. 7 illustrates the camera selection screen 700. If an operation on a “search” button. 701 illustrated in FIG. 7 is detected, the CPU 201 of the PC 200 acquires information such as a camera product name about the camera connected to the PC 200 by the USB connection, network connection, or the like, and displays the information on a dropdown list 702. The user selects a desired camera from the plurality of retrieved cameras on the dropdown list 702. The number of cameras used for automatic alignment processing is not limited to one, but two or more cameras may be selected.

An image area 703 illustrated in FIG. 7 is an area in which an image captured by the camera selected on the dropdown list 702 is displayed. For example, this operation is implemented by the CPU 201 of the PC 200 transmitting a command for instructing image capturing to the selected image capturing apparatus 300, and pasting the captured image to the image area 703. A live view image is desirably used as the image to be displayed in this area, but a still image may also be used.

The user observes the image area 703, thereby making it possible to easily perform the installment and zooming adjustment of the camera so as to enable the entire projected image (test pattern) of each projector to fall within the image capturing range.

If an operation on a “back” button 705 illustrated in FIG. 7 is detected, the screen returns to the previous screen illustrated in FIG. 6. Although not illustrated in the flowchart illustrated in FIG. 5, the processing shifts from step S503 to step S501.

A checkbox 704 illustrated in FIG. 7 is used to set whether the PC 200 automatically sets camera parameters. When a “next” button 706 is pressed to shift the screen to a subsequent screen, whether to automatically set camera parameters is switched based on whether the checkbox 704 is checked. While the detailed description is omitted, the camera parameters can be obtained by the camera performing photometry in a state where test patterns of the plurality of projectors 100 are projected.

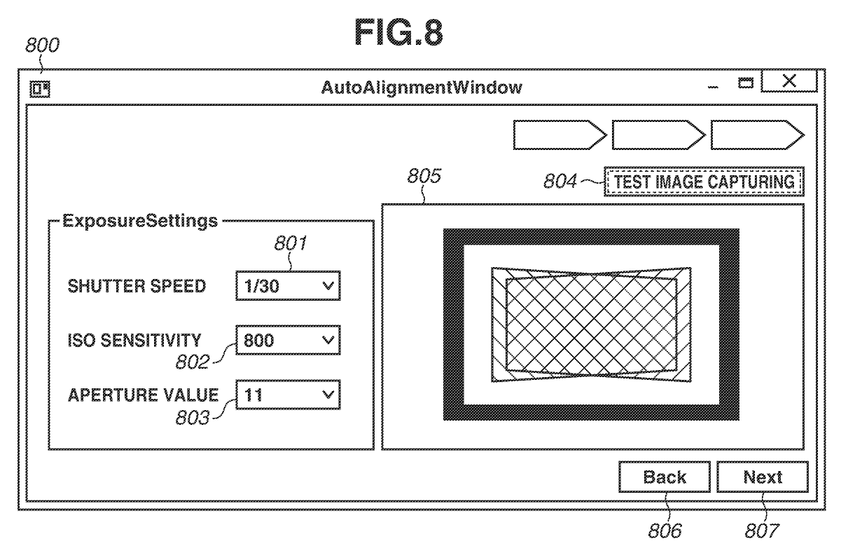

If an operation on the “next” button 706 illustrated in FIG. 7 is detected, the screen transitions to a camera parameter setting screen 800 illustrated in FIG. 8. This operation corresponds to a shift from step S503 to step S504 in FIG. 5.

In step S504 illustrated in FIG. 5, camera parameters such as a shutter speed, an International Organization for Standardization (ISO) sensitivity, and an aperture value are set. FIG. 8 illustrates the camera parameter setting screen 800.

Dropdown lists 801, 802, and 803 illustrated in FIG. 8 are used to set the shutter speed, ISO sensitivity, and aperture value, respectively, of the camera. Camera parameters that can be set are not limited to these examples. For example, a white balance and a photometry method can be set.

If an operation on “test image capturing” button 804 illustrated in FIG. 8 is detected, the PC 200 transmits a command for prompting the selected image capturing apparatus 300 to perform image capturing, acquires a captured image, and displays the captured image on an image display area 805. The image to be displayed in this case is used to check whether the parameters, such as the shutter speed, are correctly set, Accordingly, a still image is desirably used, but a live view image may also be used.

If an operation on a “back” button 806 illustrated in FIG. 8 is detected, the screen returns to the previous screen (screen illustrated in FIG. 7). Although not illustrated in the flowchart of FIG. 5, the processing shifts from step S504 to step S503.

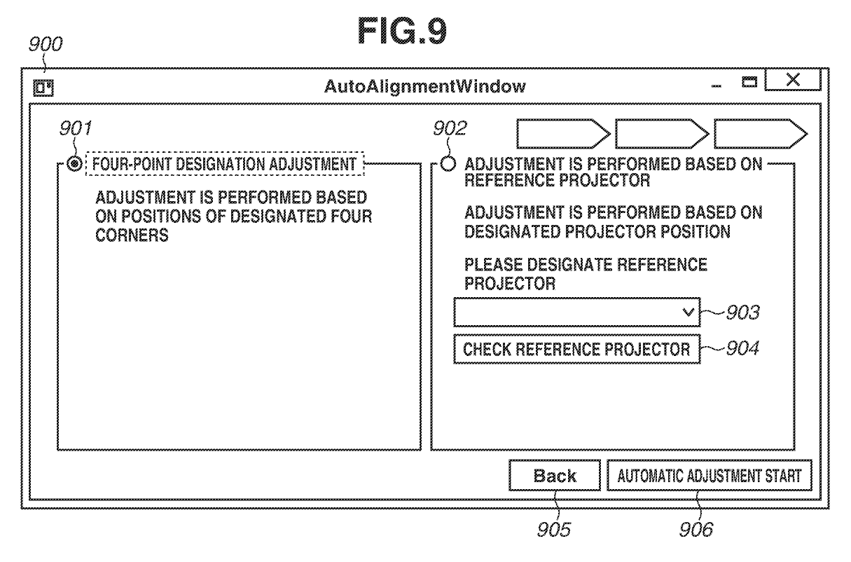

If an operation on a “next” button 807 illustrated in FIG. 8 is detected, the screen transitions to an alignment mode selection screen 900 illustrated in FIG. 9. This operation corresponds to the shifting from step S504 to step S505 in FIG. 5.

In step S505 illustrated in FIG. 5, an alignment mode is selected. In the alignment mode, any one of “4-point designation adjustment” and “adjustment based on reference projector” is selected.

The alignment mode of “4-point designation adjustment” is a mode in which the keystone correction amount is automatically determined in such a manner that the vertices of each projection area are aligned with four predetermined points, respectively. The alignment mode of “4-point designation adjustment” is effective for, for example, a case where a projection target position is clear, such as a case where a screen with a frame is set as a projection surface. The number of points for which coordinates can be adjusted may be less than four, or five or more points including coordinates other than vertices may be set.

The alignment mode of “adjustment based on reference projector” is a mode in which the keystone correction amount is automatically determined in such a manner that one projector is set as a reference projector and the projection area of another projector is aligned with the projection area of the reference projector. The automatic alignment in this mode is executed when the position of the projection area of the reference projector is adjusted to a designated position. The keystone correction amount for aligning the projection area of a projector other than the reference projector with the projection area of the reference projector is automatically determined. This function is effective when the projection target position is not clear (e.g., in the case of projecting an image onto a wall surface), unlike in the alignment mode of “4-point designation adjustment”.

FIG. 9 illustrates the alignment mode selection screen 900. The CPU 201 of the PC 200 switches to an alignment mode for adjustment depending on which one of radio buttons 901 and 902 is selected. The CPU 201 of the PC 200 stores information about the selected alignment mode in the RAM 202 of the PC 200.

A dropdown list 903 illustrated in FIG. 9 is used to select the reference projector. The projectors that can be selected in this case are projectors to be subjected to adjustment processing in step S501 in FIG. 5. The user selects a desired projector from the dropdown list, and the CPU 201 of the PC 200 stores information about the selected projector as the reference projector in the RAM 202 of the PC 200.

If an operation on a “check reference projector” button 904 illustrated in FIG. 9 is detected, the CPU 201 of the PC 200 transmits a command for displaying a specific test pattern to each of the selected projectors selected in step S501 in FIG. 5 through the network IF 206. In this case, only the reference projector is caused to project an image in such a manner that one of the color, luminance, and shape of the image is different from that of other projectors. This facilitates checking which one of the projected images on the projection surface is projected from the reference projector.

If an operation on a “back” button 905 illustrated in FIG. 9 is detected, the screen returns to the previous screen illustrated in FIG. 8. Although not illustrated in the flowchart of FIG. 5, the processing shifts from step S505 to step S504.

If an operation on a “next” button 906 illustrated in FIG. 9 is detected, the CPU 201 of the PC 200 starts automatic adjustment processing. This operation corresponds to a shift from step S504 to step S505 in FIG. 5.

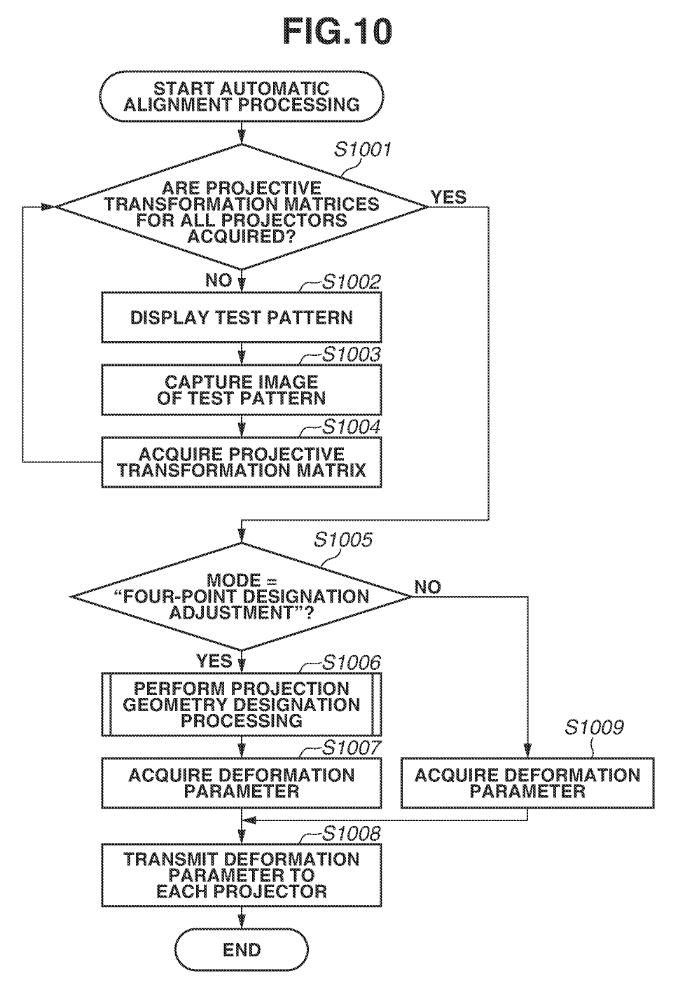

FIG. 10 is a flowchart illustrating detailed automatic alignment processing in step S506. Processing from step S1002 to step S1004 is repeatedly performed for each projector, thereby acquiring projective transformation matrices for the camera and each of the projectors to be subjected to alignment processing. More specifically, in step S1002, the CPU 201 causes the projector 100 that has not acquired the projective transformation matrix to project and display a test pattern on the projection surface 500. In step S1003, the image capturing apparatus 300 captures an image of the test pattern on the projection surface 500. In step S1004, the projective transformation matrix is acquired based on the captured image. If the projective transformation matrices for all projectors to be subjected to alignment processing are not acquired (NO in step S1001), the CPU 201 executes steps S1002 to S1004. If the projective transformation matrices for all projectors to be subjected to alignment processing is acquired (YES in step S1001), the processing proceeds to step S1005.

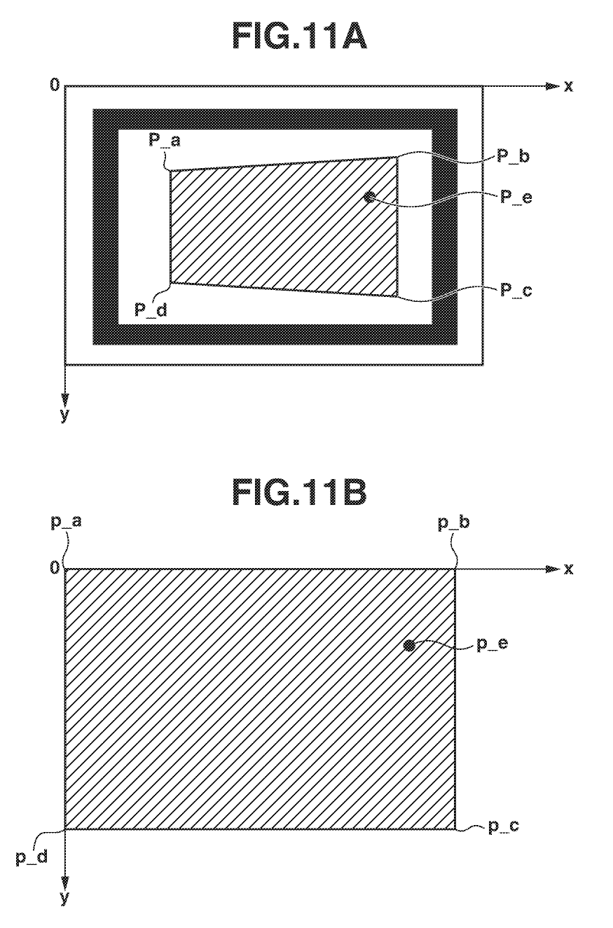

A method for calculating the projective transformation matrix will be described with reference to FIGS. 11A and 11B. FIG. 11A illustrates a camera coordinate plane (coordinate system representing captured image), and FIG. 11B illustrates a projector coordinate plane (coordinate system representing projector panel). Assuming that coordinates on the projector coordinate plane are represented by (xi, yi) and coordinates on the camera coordinate plane are represented by (Xi, Yi), the projective transformation expression is represented by Expression 3 and Expression 4 (“i” is a natural number). In this case, variables with an equal value “i” correspond to each other.

$$\begin{matrix}{x}_{i} = \frac{{aX}_{i} + {bY}_{i} + c}{{gX}_{i} + {hY}_{i} + 1} & ( 3 ) \\ {y}_{i} = \frac{{dX}_{i} + {eY}_{i} + f}{{gX}_{i} + {hY}_{i} + 1} & ( 4 )\end{matrix}$$

where “a” to “h” each represent a predetermined constant.

The above-described Expression 3 and Expression 4 are transformed to obtain the following Expression 5 which is expressed using a matrix.

$$λ ( \begin{matrix}x \\ y \\ 1\end{matrix} ) = M ( \begin{matrix}X \\ Y \\ 1\end{matrix} ) , M = ( \begin{matrix}a & b & c \\ d & e & f \\ g & h & 1\end{matrix} ) \qquad ( 5 )$$

In Expression (5), M represents a projective transformation matrix. This projective transformation matrix can be calculated by substituting four sets of corresponding points (x1, y1, X1, Y1), (x2, y2, X2, Y2), (x3, y3, X3, Y3), and (x4, y4, X4, Y4) into Expression 3 and Expression 4. In other words, if correspondences between at least four coordinates on both the camera coordinate plane and the projector coordinate plane are known, the projective transformation matrix can be calculated.

For example, if each projector projects a quadrangular shape (shaded area illustrated in FIG. 11B) and the coordinates of vertices of the quadrangular shape projected from the projector can be detected in the captured image, the projective transformation matrix can be calculated. Known techniques may be used to detect the coordinates of vertices, and thus the description of the method for detecting the coordinates of vertices is omitted.

In FIG. 11A and FIG. 11B, camera coordinate planes P_a, P_b, P_c, and P_d correspond to projector coordinate planes p_a, p_b, p_c, and p_d, respectively. The projective transformation matrix is calculated based on the correspondences between the four known points. The use of the calculated projective transformation matrix enables execution of the projective transformation at an unknown coordinate point. For example, by multiplying the calculated projective transformation matrix to a point P_e on the camera coordinate plane, the corresponding point p_e on the projector coordinate plane can be calculated. Further, by multiplying the inverse matrix of the calculated projective transformation matrix to the point p_e on the projector coordinate plane, the corresponding point P_e on the camera coordinate plane can be calculated.

Although the projective transformation matrix can be calculated by the above-described method, the image to be projected by each projector when the image capturing apparatus 300 captures an image is not limited to a quadrangular shape. Any image can be used as long as the correspondences between at least four coordinates on both the camera coordinate plane and the projector coordinate plane can be obtained.

Referring back to FIG. 10, the automatic alignment processing will be described. The CPU 201 of the PC 200 repeatedly performs steps S1002 to S1004 to calculate the projective transformation matrix for each projector, and stores the calculated projective transformation matrices in the RAM 202 of the PC 200.

In step S1005, the CPU 201 switches the method for calculating a deformation parameter depending on information about the alignment mode designated by the user that is stored in the RAM 202. In the present exemplary embodiment, the description of deformation in the mode of “adjustment based on reference projector” in step S1009 is omitted.

In step S1005 illustrated in FIG. 10, if it is determined that the user has selected the “4-point designation adjustment” mode (YES in step S1005), the processing proceeds to step S1006 to perform “projection geometry designation processing”. If it is determined that the user has selected the mode of “adjustment based on the reference projector” (NC) in step S1005), the processing proceeds to step S1009.

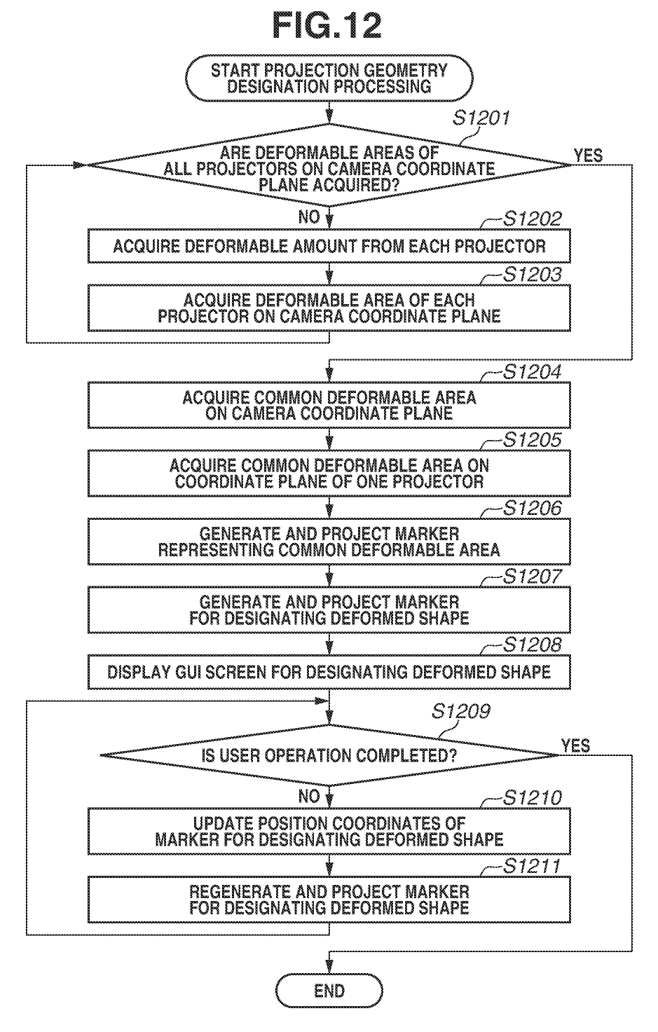

The “projection geometry designation processing” in step S1006 will be described with reference to a detailed flowchart of FIG. 12. First, the CPU 201 of the PC 200 repeatedly performs processing of steps S1202 to S1203 for each projector, thereby, acquiring the deformable area of each projector on the camera coordinate plane. If the deformable areas of all projectors on the camera coordinate plane are not acquired (NO in step S1201), the processing proceeds to step S1202. If the deformable areas of all projectors on the camera coordinate plane are acquired (YES in step S1201), the processing proceeds to step S1204. In step S1202, the CPU 201 of the PC 200 transmits a command for requesting the projector 100 to transmit a keystone deformable amount through the network IF 206. Upon receiving the command for requesting the keystone deformable amount, the projector 100 returns information including the keystone deformable amount of the projector 100 to the PC 200. The PC 200 stores the keystone deformable amount received from the projector 100 into the RAM 202 of the PC 200.

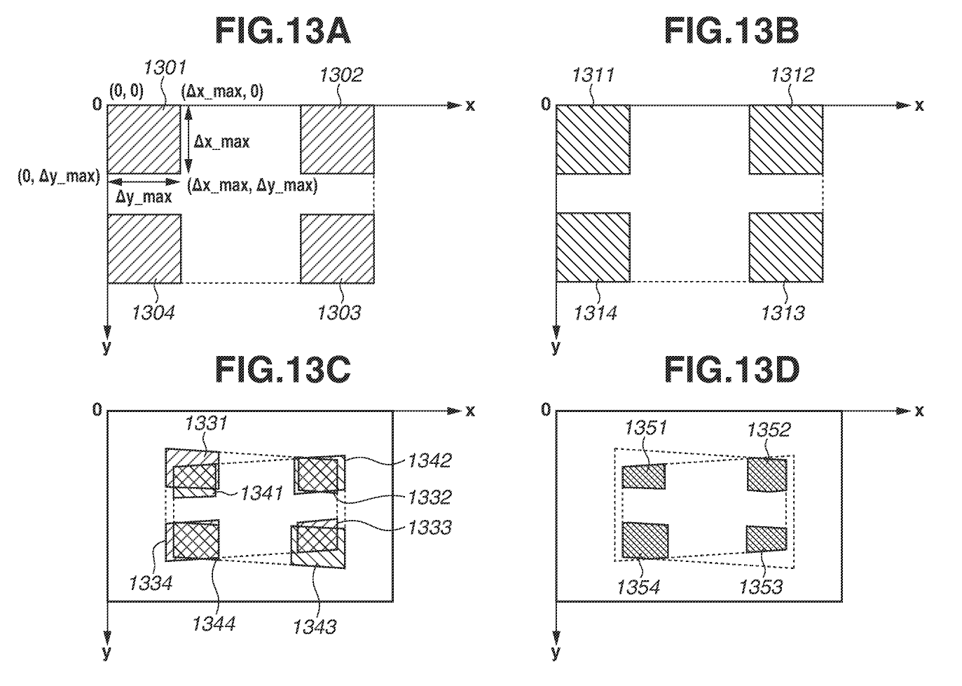

Next, in step S1203, the CPU 201 of the PC 200 acquires a keystone deformable area on the projector coordinate plane, and performs projective transformation of the keystone deformable area, thereby acquiring the deformable area on the camera coordinate plane. FIGS. 13A and 13B each illustrate the keystone deformable area for the projector 100. Shaded areas 1301 to 1304 illustrated in FIG. 13A represent a keystone deformable area by the projector 100a, and shaded areas 1311 to 1314 illustrated in FIG. 13B represent a respective keystone deformable area by the projector 100b. Each keystone deformable area can be obtained based on the resolution of the panel of each projector and the keystone deformable amount (Δx_max, Δy_max) of each projector.

Coordinates of the upper left deformable area 1301 are given below by way of example.
Coordinates of the upper left vertex of the upper left deformable area 1301=(0, 0),
Coordinates of the upper right vertex of the upper left deformable area 1301=(Δx_max, 0),
Coordinates of the lower right vertex of the upper left deformable area 1301 (Δx_max, Δy_max), and
Coordinates of the lower left vertex of the upper left deformable area 1301=(0, Δy_max).

The CPU 201 of the PC 200 obtains the coordinates of the respective deformable areas for all the projectors 100 to be subjected to alignment processing. Next, the CPU 201 of the PC 200 reads the projective transformation matrix acquired in step S1004 illustrated in FIG. 10 from the RAM 202, and projects the coordinates of vertices of each deformable area on the camera coordinate plane by using the projective transformation matrix. FIG. 13C illustrates the result of performing projective transformation of the deformable areas of each of the projector 100a and the projector 100b on the camera coordinate plane. Shaded areas 1331 to 1334 each represent the result of performing projective transformation of the keystone deformable area of each vertex by the projector 100a on the camera coordinate plane, and shaded areas 1341 to 1344 each represent the result of performing projective transformation of the keystone deformable area of each vertex by the projector 100b on the camera coordinate plane.

In step S1204, the CPU 201 of the PC 200 acquires a deformable area common to the plurality of projectors on the camera coordinate plane. The common deformable area is calculated by applying a known mathematical technique to the coordinates of vertices of a polygon representing a deformable area of each projector. Hatched areas 1351 to 1354 illustrated in FIG. 13D represent deformable vertex areas common to the plurality of projectors on the camera coordinate plane. More specifically, a common area included in both the deformable area 1331 (1332 to 1334) of the projector 100a and the deformable area 1341 (1342 to 1344) of the projector 100b corresponds to the common deformable area 1351 (1352 to 1354). In step S1204, if the CPU 201 of the PC 200 determines that at least one common deformable area is not present, the CPU 201 may cause the display unit 205 of the PC 200 to display a warning message. As the warning message, a specific work instruction (e.g., “Please zoom the projector”) may be displayed. In addition to the display of the warning message, the CPU 201 of the PC 200 may perform optical control (optical zooming or lens shifting) of each projector in such a manner that the common deformable area is present on the projection surface.

Next, in step S1205, the CPU 201 of the PC 200 selects one of the projectors to be subjected to alignment processing, and projects the common deformable areas obtained in step S1204 on the coordinate plane of the selected projector.

In step S1206, the CPU 201 of the PC 200 generates a marker representing each of the common deformable areas, and causes the projector selected in step S1205 to project the marker.

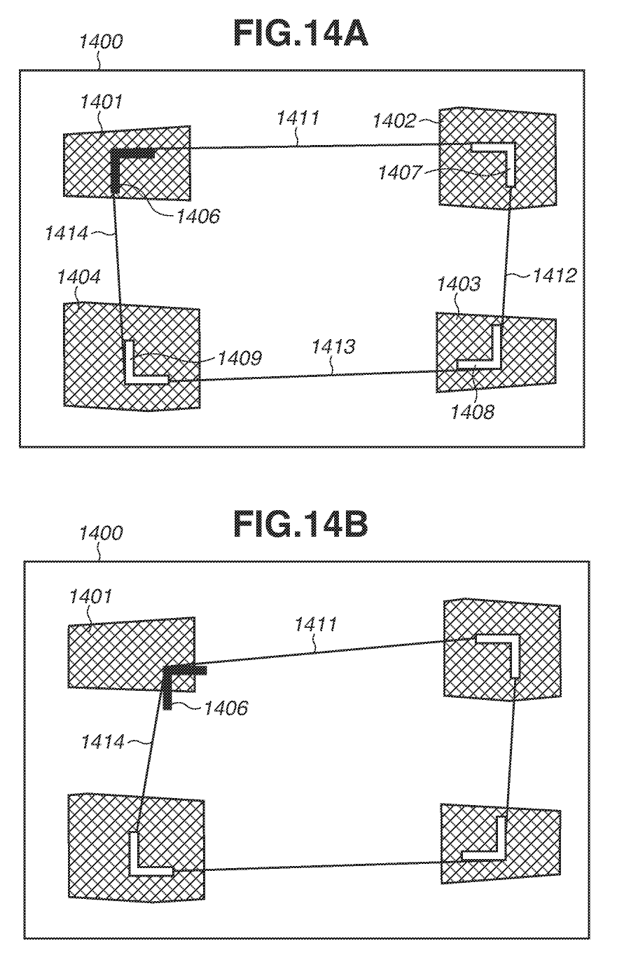

In this case, the CPU 201 of the PC 200 transmits a command through the network IF 206 so as to bring projectors other than the projector that projects the common deformable areas into a non-projection state. As a result, it is possible to prevent other projectors from disturbing the projection of the common deformable areas onto the projection snake. FIGS. 14A and 149 illustrate examples of a marker to be projected on a projection surface 1400. Examples of the marker representing the common deformable area include images 1401 to 1404 illustrated in FIGS. 14A and 14B, and the marker is displayed as a quadrangular hatched area. The color, line width, pattern, and the like of the marker representing the common deformable area are not particularly limited. For example, any of the markers of display forms discussed in Japanese Patent Application Laid-Open No. 2009-200557 may be used.

In step S1207, the CPU 201 of the PC 200 generates a deformed shape designation marker, and causes the projector selected in step S1205 to further perform projection. Examples of the marker for designating the deformed shape include images illustrated in FIGS. 14A and 14B. FIGS. 14A and 149 illustrate markers each including four L-shaped markers 1406 to 1409 and four lines 1411 to 1414 connecting the L-shaped markers. Four vertices of the projection area (projected image) of the projector 100a and four vertices of the projection area (projected image) of the projector 100b, which are obtained after the automatic alignment processing (after deformation), are respectively aligned to form one superimposed area (superimposed image). Each of the L-shaped markers is an image indicating a vertex of the superimposed area obtained after the automatic alignment processing. The shape and color of the marker are not particularly limited, as long as at least four coordinates can be designated on the projection surface. As illustrated in FIG. 14A, an initial position of the marker for designating the deformed shape is determined in such a manner that the L-shaped markers 1406 to 1409 are located within the markers 1401 to 1404 each representing the common deformable area. The position set in this case may be, for example, the barycenter of the common deformable area, or a position on a predetermined vertex of the common deformable area. Alternatively, the position may be a characteristic position (e.g., a screen corner, or an intersection between lines projected by a laser marker) located within the common deformable area on the camera coordinate plane. Referring to FIG. 14A, the L-shaped markers are disposed in such a manner that the entire L-shaped marker is included in the corresponding common deformable area, but instead the L-shaped marker may be disposed in such a manner that only the portion corresponding to the vertex of the superimposed area of the L-shaped marker is included in the common deformable area.

As the marker representing the common deformable area and the marker for designating the deformed shape, images generated by the CPU 201 of the PC 200 may be transmitted through the network IF 206 or the video output unit 207. Alternatively, the CPU 201 of the PC 200 may transmit a command for causing the projector 100 to render any line or polygon through the network IF 206, and the CPU 101 of the projector 100 may render a marker image based on the result of interpreting the received command.

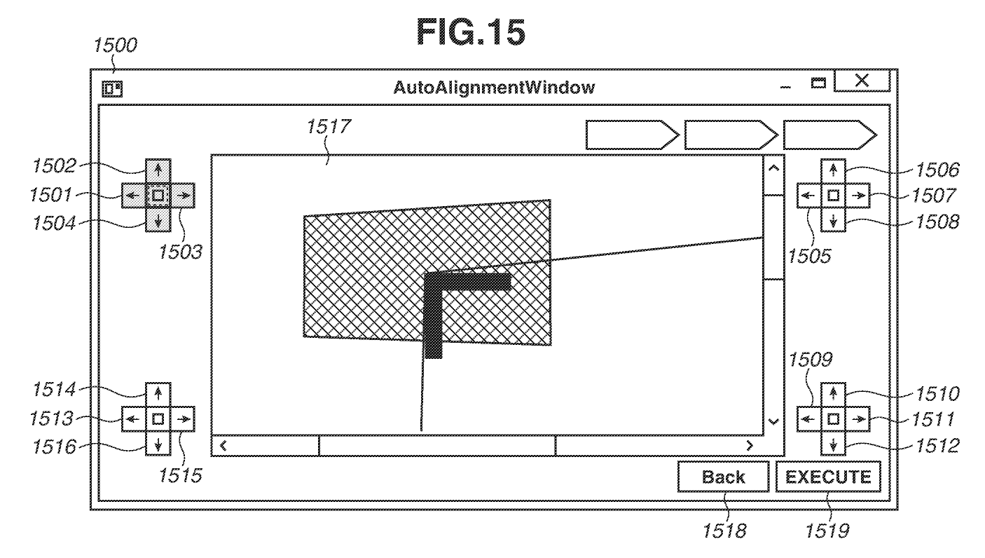

After the processing in step S1207 is completed, in step S1208, the CPU 201 of the PC 200 displays a GUI screen 1500 for designating a deformed shape illustrated in FIG. 15.

FIG. 15 illustrates buttons 1501 to 1504 for operating the marker 1406 corresponding to the upper left vertex, buttons 1505 to 1508 for operating the marker 1407 corresponding to the upper right vertex, buttons 1509 to 1512 for operating the marker 1408 corresponding to the lower right vertex, and buttons 1513 to 1516 for operating the marker 1409 corresponding to the lower left vertex. These operation buttons are buttons for accepting an instruction for moving the markers 1406 to 1409 in each direction indicated by an arrow displayed in a corresponding button.

An image area 1517 illustrated in FIG. 15 is an area for displaying a live view image captured and acquired by instructing the image capturing apparatus 300 to which the PC 200 is connected. The user operates any one of the operation buttons 1501 to 1516 while directly observing the projection surface, or viewing the image area 1517, thereby, operating the marker for designating the deformed shape.

If an operation on the operation buttons 1501 to 1516 is detected, in step S1210, the CPU 201 of the PC 200 updates the position coordinates of the marker for designating the deformed shape on the camera coordinate plane stored in the RAM 202 of the PC 200. Further, in step S1211, the CPU 201 regenerates a marker image at the updated position coordinates, and causes the projector selected in step S1205 to project the regenerated marker image again. FIG. 14B illustrates the result obtained when the user presses the operation buttons 1503 and 1504 several times from the initial state illustrated in FIG. 14A. On the projection surface 1400 illustrated in FIG. 149, the positions of the L-shaped marker 1406 and two lines 1411 and 1414 adjacent to the L-shaped marker 1406 are changed and the changed positions are displayed.

The operation buttons 1501 to 1516 can be operated (NO in step S1209) until the user operates an “execute” button 1519 illustrated in FIG. 15. If the “execute” button 1519 illustrated in FIG. 15 is operated by the user (YES in step S1209), the flowchart illustrated in FIG. 12 is terminated and the processing proceeds to step S1007 in FIG. 10.

Referring back to FIG. 10, the automatic alignment processing will be described.

In step S1007, the CPU 201 of the PC 200 acquires the keystone correction amount for forming one superimposed image in which the projected images of the plurality of projectors are completely superimposed on the projection surface. The CPU 201 calculates the keystone correction amount for each projector by projecting the coordinates of the deformed shape on the camera coordinate plane that are stored in the RAM 202 of the PC 200 on the plane of each projector by using the projective transformation matrices acquired in step S1004.

In step S1008, the CPU 201 of the PC 200 transmits, to each projector 100, the keystone correction amount calculated in step S1007 through the network IF 206. Upon receiving the keystone correction amount from the PC 200, the projector 100 transmits the received keystone correction amount to the image processing unit 109, and executes correction of the shape of the input image.

According to the present exemplary embodiment, in the case of performing keystone correction on the plurality of projectors, the deformable range common to all projectors can be visualized, which leads to an improvement in user-friendliness.

The deformable range common to the projectors can be presented to the user (e.g., as illustrated in FIG. 13C) only by preparing a plurality of projectors discussed in Japanese Patent Application Laid-Open No. 2009-200557 and changing the color or pattern of the image representing the deformable range for each projector. However, in this method, if three or more projectors are used for stack projection, it is extremely difficult to identify the deformable range common to all projectors. However, according to the present exemplary embodiment, the deformable range common to all projectors is obtained and only the common deformable range is projected onto the projection surface as illustrated in FIG. 13D, thereby facilitating the identification of the common deformable range.

While the first exemplary embodiment illustrates an example in which the deformable area common to the projectors is acquired using a mathematical method, the acquisition method is not limited to this method. A second exemplary embodiment illustrates a method for acquiring the deformable area common to the projectors by using image processing.

Components in the second exemplary embodiment are similar to those in the first exemplary embodiment, except for the method for acquiring the deformable area common to the projectors, and thus the descriptions of components other than the acquisition method are omitted.

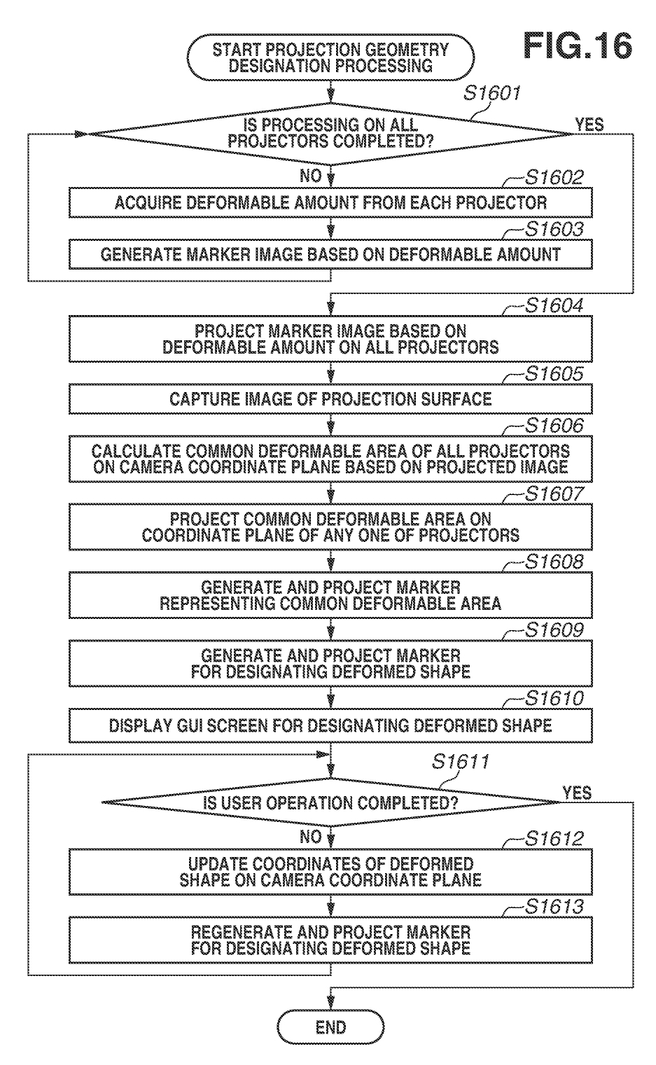

FIG. 16 is a detailed flowchart of step S1.006 according to the second exemplary, embodiment as illustrated in FIG. 10 described in the first exemplary embodiment.

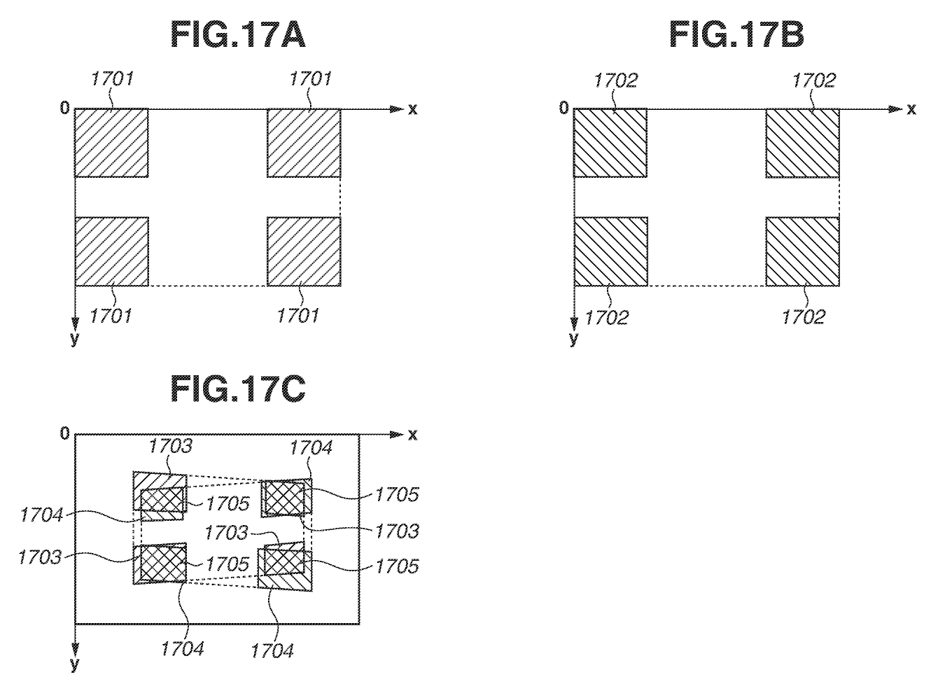

First, the CPU 201 of the PC 200 repeatedly performs steps S1602 and S1603 to generate a marker image based on the deformable amount. More specifically, in step S1602, the CPU 201 acquires the deformable amount from the projector 100 that has not completed processing, and in step S1603, the CPU 201 generates a marker image based on the deformable amount. If the processing on all projectors is not completed (NO in step S1601), the CPU 201 executes steps S1602 and S1603. If the processing on all projectors is completed (YES in step S1601), the processing proceeds to step S1604. In step S1604, each projector is caused to project and display the marker image based on the deformable amount. FIGS. 17A and 17B illustrate examples of the marker image based on the deformable amount. FIG. 17A illustrates deformable areas 1701 corresponding to vertices projected by the projector 100a. FIG. 17B illustrates deformable areas 1702 corresponding to vertices projected by the projector 100b. In the case of generating the marker image for all projectors, the CPU 201 of the PC 200 changes the color of the deformable area for each projector, or sets the deformable areas for all projectors with the same color and luminance.

By modifying the marker image as described above, when all projectors simultaneously project the marker images, the projection surface and the captured image of the projection surface have the following features.

FIG. 17C represents a state where all projectors simultaneously project the marker images and capture images of the marker images. FIG. 17C illustrates areas 1703 in which only the projector 100a projects the deformable area, and areas 1704 in which only the projector 100b projects the deformable area. FIG. 17C illustrates areas 1705 in which both the projector 100a and the projector 100b each project the deformable area. In other words, each of the areas 1705 is an area included in both the area 1703 and the area 1704. In a case where the color of the marker image is changed for each projector, for example, when the projector 100a projects a red marker and the projector ION projects a green marker, the areas 1705, i.e., the deformable areas common to the plurality of projectors are represented by yellow, which is a mixed color of red and green. When the same color and luminance are set, the luminance only in the areas 1705 is higher than that in the other areas.

By using the above-described features, the deformable area common to the projectors on the camera coordinate plane can be acquired. In a case of using color information, the common deformable area can be obtained by applying processing of determining whether the hue in each pixel is close to a predetermined hue to all pixels of the captured image. Further, in a case of using luminance information, the common deformable area can be obtained by applying processing of determining whether the luminance in each pixel is greater than or equal to a predetermined threshold to all pixels of the captured image. The processing using the hue or luminance is merely an example, and other pixel information such as brightness or color saturation may also be used.

In step S1605, the CPU 201 of the PC 200 causes the image capturing apparatus 300 to capture an image of the projection surface on which the marker images of all projectors are simultaneously projected and displayed as described above, and in step S1606, the CPU 201 calculates the deformable area common to all projectors on the camera coordinate plane based on the captured image.

Processing from step S1607 to step S1613 illustrated in FIG. 16 is the same as the processing from step S1205 to step S1211 illustrated in FIG. 12, and thus descriptions thereof are omitted.

According to the present exemplary embodiment, like in the first exemplary embodiment, when keystone correction is performed on the plurality of projectors, the deformable amount common to all projectors can be visualized, which leads to an improvement in user-friendliness.

In a third exemplary embodiment, a case is described where rendering of the marker image described in the “projection geometry designation processing” illustrated in FIG. 12 according to the first exemplary embodiment is carried out using a network command transmitted from the PC 200 to each projector.

In this processing, first, the CPU 201 of the PC 200 transmits a command for causing the projector 100 to render any line or polygon through the network IF 206. Further, the CPU 101 of the projector 100 interprets the command received via the network IF 108, and implements the processing by storing, in the VRAM 106, the line or polygon based on the content of the command.

In the first exemplary embodiment, the projector selected in step S1205 is caused to project the marker representing the common deformable area in step S1206 illustrated in FIG. 12. Further, in step S1207, the marker for designating the deformed shape is projected by the same projector. However, the markers may be projected by different projectors, respectively. In the present exemplary embodiment, a method for projecting the markers by different projectors, respectively, will be described.

First, differences between the markers 1401 to 1404 representing the common deformable areas illustrated in FIGS. 14A and 149 and the markers 1406 and 1409 for designating the deformed shape will be described. The markers 1401 to 1404 representing the common deformable areas are determined based on the projection position of each projector and the deformable area of each projector. More specifically, each of the markers 1401 to 1404 is a marker whose position does not change from the start of the “projection geometry designation processing” until the end of the processing, and thus there is no need to sequentially update the position of each of the markers 1401 to 1404. On the other hand, each of the markers 1406 to 1409 for designating the deformed shape is a marker whose position needs to be updated by a user operation as illustrated in steps S1209, S1210, and S1211 in FIG. 12, and thus is required to have a high readiness.

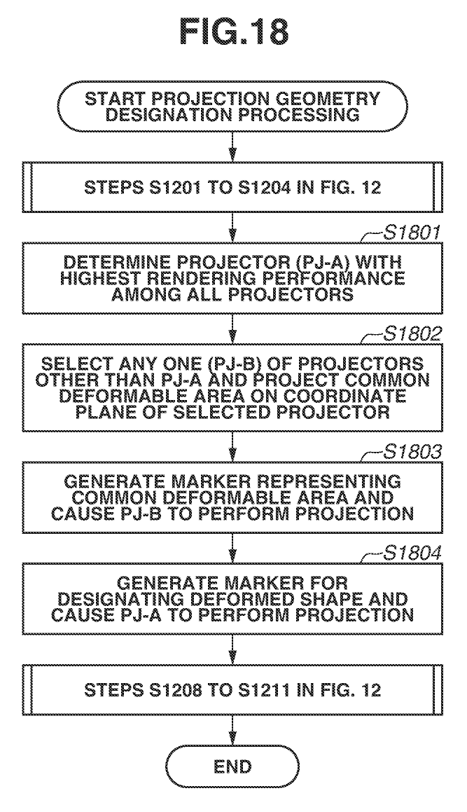

When the markers with different requirements are rendered by the CPU of a single projector, a long processing time is required for rendering markers for which sequentially updating is not required. Thus, there is a possibility that the markers that are required to have a high response speed cannot be rendered with a high response speed. A method for solving this problem will be described with reference to FIG. 18.

FIG. 18 is a flowchart illustrating a modification of the “projection geometry designation processing” illustrated in FIG. 12 described in the first exemplary embodiment. First, when the projection geometry designation processing is started, processing similar to that in steps S1201 to S1204 illustrated in FIG. 12 is performed. This processing has been described above, and thus the detailed descriptions thereof are omitted.

In step S1801, the CPU 201 of the PC 200 transmits a command for acquiring a marker rendering capability to each projector through the network IF 206. The projector 100, which has received the command, returns information indicating the marker rendering capability to the PC 200. This information is, for example, an operating frequency of the CPU 101 of the projector 100. Upon acquiring the information of the marker rendering capability from all projectors, the CPU 201 of the PC 200 determines a projector (hereinafter, referred to as PJ-A) with the highest rendering capability from among the projectors.

In step S1802, the CPU 201 of the PC 200 selects a projector (hereinafter, referred to as PJ-B) other than the PJ-A determined in step S1801, and projects the common deformable area obtained in step S1204 onto the coordinate plane of the projector.

In step S1803, the CPU 201 of the PC 200 generates markers representing the common deformable area, and projects the generated markers on the PJ-B selected in step S1802.

In step S1804, the CPU 201 of the PC 200 generates markers for designating the deformed shape, and causes the PJ-A selected in step S1801 to project the generated markers.

Subsequent steps are similar to steps S1208 to S1211 illustrated in FIG. 12, and thus the descriptions thereof are omitted.

According to the present exemplary embodiment, rendering of “markers for designating a projection geometry” that is required to have a high response speed can be achieved by the projector with the highest rendering capability, and rendering of “markers representing a common deformable area” that does not require sequential updating can be achieved by another projector. Consequently, it is possible to present updating of the “markers for designating a projection geometry” to the user who is operating the markers, while maintaining a high response performance.

### OTHER EMBODIMENTS

Embodiment(s) of the present disclosure can also be realized by a computer of a system or apparatus that reads out and executes computer executable instructions e.g., one or more programs) recorded on a storage medium (which may also be referred to more fully as a ‘non-transitory computer-readable storage medium’) to perform functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Applications No. 2018-081157, filed Apr. 20, 2018, and No. 2018-081158, filed Apr. 20, 2018, which are hereby incorporated by reference herein in their entirety.

What is claimed is:

1. A projection control apparatus that controls a plurality of projection apparatuses including a first projection apparatus configured to project a first projected image and a second projection apparatus configured to project a second projected image, the projection control apparatus comprising:
an acquisition unit configured to acquire a common area in which the first projected image and the second projected image are deformable; and
a control unit configured to cause at least one of the plurality of projection apparatuses to project an image representing the common area.

2. The projection control apparatus according to claim 1, wherein the common area is an area included in both of a first area and a second area, the first area being an area in which a vertex of the first projected image is movable during deformation of the first projected image, and the second area being an area in which a vertex of the second projected image is movable during deformation of the second projected image.

3. The projection control apparatus according to claim 1, wherein the control unit causes, in a case where the acquisition unit has not acquired the common area because the common area is not present, at least one of the plurality of projection apparatuses to project an image indicating a warning message.

4. The projection control apparatus according to claim 1, wherein the control unit causes at least one of the plurality of projection apparatuses to project an image for designating a shape obtained after deformation of the first projected image and the second projected image.

5. The projection control apparatus according to claim 4, wherein the image for designating the shape is an image representing a vertex of a superimposed image formed by superimposing the first projected image obtained after deformation and the second projected image obtained after deformation.

6. The projection control apparatus according to claim 4, further comprising an acceptance unit configured to accept an operation to move the image for designating the shape.

7. The projection control apparatus according to claim 6, wherein the control unit deforms the first projected image and the second projected image based on the operation.

8. The projection control apparatus according to claim 4, wherein the control unit causes the first projection apparatus to project the image representing the common area, and causes the second projection apparatus to project the image for designating the shape.

9. The projection control apparatus according to claim 8, wherein the second projection apparatus has a rendering capability higher than the rendering capability of the first projection apparatus.

10. The projection control apparatus according to claim 8, further comprising an acceptance unit configured to accept an operation to move the image for designating the shape,
wherein the control unit causes the second projection apparatus to change a position at which the image for designating the shape is projected based on the operation.

11. The projection control apparatus according to claim 1, wherein the acquisition unit acquires the common area based on a captured image obtained by an image capturing unit capturing the first projected image and the second projected image.

12. The projection control apparatus according to claim 11, wherein the acquisition unit calculates the common area based on the captured image, a resolution of the first projection apparatus, a deformable amount on a panel of the first projection apparatus, a resolution of the second projection apparatus, and a deformable amount on a panel of the second projection apparatus.

13. The projection control apparatus according to claim 1, further comprising a communication unit configured to communicate with the first projection apparatus and the second projection apparatus.

14. A projection control method for controlling a plurality of projection apparatuses including a first projection apparatus configured to project a first projected image and a second projection apparatus configured to project a second projected image, the projection control method comprising:
acquiring a common area in which the first projected image and the second projected image are deformable; and
projecting an image representing the common area.

15. A non-transitory computer readable medium storing a program for causing a computer to execute a projection control method for controlling a plurality of projection apparatuses including a first projection apparatus configured to project a first projected image and a second projection apparatus configured to project a second projected image, the projection control method comprising:
acquiring a common area in which the first projected image and the second projected image are deformable; and
projecting an image representing the common area.
